(19) United States
(12) Patent Application Publication
(10) Pub. No.: US 2026/0299695 A1
(43) Pub. Date: Oct. 1, 2026

(54) DISPLAY APPARATUS AND PREPARATION METHOD THEREFOR

(71) Applicants: Beijing BOE Technology Development Co., Ltd., Beijing (CN); BOE TECHNOLOGY GROUP CO., LTD., Beijing (CN)

(72) Inventors: Feng Zhang, Beijing (CN); Tengfei Liu, Beijing (CN)

(73) Assignees: Beijing BOE Technology Development Co., Ltd., Beijing (CN); BOE TECHNOLOGY GROUP CO., LTD., Beijing (CN)

(21) Appl. No.: 19/489,339

(22) PCT Filed: May 29, 2024
(86) PCT No.: PCT/CN2024/095932

§ 371 Date: Dec. 2, 2025

(30) Foreign Application Priority Data
Jun. 19, 2023 (CN) 202310729215.6

(51) Int. Cl. G06F 3/01; B06B 1/02; B06B 1/06; G06F 3/041

(52) U.S. Cl. CPC G06F 3/016; B06B 1/0292; B06B 1/0622; G06F 3/0412; G06F 3/0416; G06F 2203/04103

(57) ABSTRACT

This disclosure provides a display apparatus and a method for preparing the same. The display apparatus comprises: a touchscreen, which is provided with a touch-control display surface and a haptic feedback surface that are arranged opposite to each other, the touchscreen being configured to obtain a touch position; an ultrasonic transducer array, which is located on the haptic feedback surface and comprises a plurality of ultrasonic transducers arranged in an array, wherein each of the ultrasonic transducers is configured to operate independently; and a control module provided with an input terminal and an output terminal, wherein the input terminal is electrically attached to the touchscreen, the output terminal is electrically attached to the ultrasonic transducers, and the control module is configured to control the ultrasonic transducer located at the touch position to perform a vibration feedback.

### CROSS-REFERENCE TO RELATED APPLICATION

The present application claims a priority to Chinese Patent Application No. 202310729215.6 filed in China on Jun. 19, 2023, disclosure of which is hereby incorporated by reference in its entirety.

### TECHNICAL FIELD

The present disclosure relates to the field of display technology, and in particular, to a method for preparing a display apparatus.

### BACKGROUND

Touch technology is the most widely used computer input method, just behind keyboard, mouse, and voice input. A User can perform various operations on a host computer simply by gently touching an icon or text on a touchscreen with a finger, which makes human-computer interaction more direct and straightforward. With the development of technology, some touchscreens are also equipped with a haptic feedback function, which help users quickly determine whether their input operations are effective. For example, when a user is driving a vehicle, the haptic feedback from the touchscreen can promptly inform the user that his operation was successful, thereby reducing user distraction and improving driving safety. Currently, in most touchscreens with haptic feedback functionality, devices such as eccentric motors or linear motors are mounted on a vibration plate to drive the plate to vibrate upon detection of a touch, thereby realizing the haptic feedback.

However, when a user touches a certain position on the touchscreen, the entire touchscreen vibrates. This approach not only results in high power consumption, but also fails to reproduce the haptic sensation specific to the touched position. Furthermore, it is incapable of simultaneously providing haptic feedbacks for multiple positions, which limits the applicability of touchscreens.

### SUMMARY

In a first aspect, the present disclosure provides a display apparatus, including: a touchscreen, which is provided with a touch-control display surface and a haptic feedback surface that are arranged opposite to each other, the touchscreen being configured to obtain a touch position; an ultrasonic transducer array, which is located on the haptic feedback surface and includes a plurality of ultrasonic transducers arranged in an array, where each of the ultrasonic transducers is configured to operate independently; and a control module provided with an input terminal and an output terminal, where the input terminal is electrically attached to the touchscreen, the output terminal is electrically attached to the ultrasonic transducers, and the control module is configured to control the ultrasonic transducer located at the touch position to perform a vibration feedback.

In one embodiment, the ultrasonic transducer array is a piezoelectric micromachined ultrasonic transducer array or a capacitive micromachined ultrasonic transducer array.

In one embodiment, the piezoelectric micromachined ultrasonic transducer array includes a substrate, a structural layer, a first electrode layer, a piezoelectric layer, and a second electrode layer, which are stacked in sequence; the substrate has a plurality of through-holes arranged in an array, and the structural layer is partially exposed through the through-holes; the first electrode layer and/or the second electrode layer is a patterned electrode layer including a plurality of sub-electrode blocks arranged in an array, the sub-electrode blocks being each disposed opposite to one of the through-holes; and a surface of the substrate facing away from the structural layer faces toward the haptic feedback surface.

In one embodiment, the piezoelectric micromachined ultrasonic transducer array further includes a vibration matching layer located on a surface of the second electrode layer facing away from the piezoelectric layer. The vibration matching layer has a low acoustic impedance and enables a high acoustic velocity, which can effectively reduce the reflection and loss of ultrasonic waves generated by the ultrasonic transducer, thereby improving the transmission efficiency of the ultrasonic waves and increasing the vibration intensity, which is beneficial for improving the haptic feedback effect.

In one embodiment, the first electrode layer includes a plurality of first sub-electrode blocks arranged in an array, and the second electrode layer includes a plurality of second sub-electrode blocks arranged in an array. The first sub-electrode blocks and the second sub-electrode blocks are each disposed opposite to one of the through-holes, and the second sub-electrode block is smaller in area than the first sub-electrode block. This arrangement is advantageous for achieving a better vibration effect, thereby contributing to a better haptic feedback effect.

In one embodiment, an area ratio of the second sub-electrode block to the first sub-electrode block is from 0.5 to 0.8.

In one embodiment, the piezoelectric micromachined ultrasonic transducer array includes a sealing layer, a substrate, a structural layer, a first electrode layer, a piezoelectric layer, and a second electrode layer, which are stacked in sequence; the substrate has a plurality of through-holes arranged in an array, and the through-holes, the structural layer, and the sealing layer form sealed cavities; the first electrode layer and/or the second electrode layer is a patterned electrode layer including a plurality of sub-electrode blocks arranged in an array, the sub-electrode blocks being each disposed opposite to one of the through-holes; and a surface of the second electrode layer facing away from the piezoelectric layer faces toward the haptic feedback surface.

In one embodiment, the sealing layer is a vibration matching layer.

In one embodiment, the touchscreen includes a substrate, which is a flexible substrate. This helps to improve the vibration transmission effect, thereby enhancing the haptic feedback effect.

In a second aspect, the present disclosure provides a method for preparing a display apparatus, including: forming a touchscreen, which is provided with a touch-control display surface and a haptic feedback surface that are arranged opposite to each other, the touchscreen being configured to obtain a touch position; forming an ultrasonic transducer array, which is located on the haptic feedback surface and includes a plurality of ultrasonic transducers arranged in an array, where each of the ultrasonic transducers is configured to operate independently; and providing a control module provided with an input terminal and an output terminal, where the input terminal is electrically attached to the touchscreen, the output terminal is electrically attached to the ultrasonic transducers, and the control module is configured to control the ultrasonic transducer located at the touch position to perform a vibration feedback.

In one embodiment, the method for preparing the display apparatus includes: forming the touchscreen, and after forming the touchscreen, forming the ultrasonic transducer array on the haptic feedback surface of the touchscreen.

In one embodiment, the step of forming the ultrasonic transducer array on the haptic feedback surface includes: forming a substrate on the haptic feedback surface, where the substrate has a plurality of through-holes arranged in an array; forming a structural layer on a surface of the substrate facing away from the touchscreen, where the through-holes form sealed cavities; forming a first electrode layer on a surface of the structural layer facing away from the touchscreen; forming a full-surface piezoelectric layer on a surface of the first electrode layer facing away from the touchscreen; forming a second electrode layer on a surface of the piezoelectric layer facing away from the touchscreen; where the first electrode layer and/or the second electrode layer is a patterned electrode layer including a plurality of sub-electrode blocks arranged in an array, the sub-electrode blocks being each disposed opposite to one of the through-holes.

In one embodiment, the step of forming the substrate on the haptic feedback surface includes: forming a photoresist layer on the haptic feedback surface, and etching the photoresist layer to obtain the substrate.

In one embodiment, the step of forming the structural layer on the surface of the substrate facing away from the touchscreen includes: pre-fabricating the structural layer, and adhering the structural layer to the surface of the substrate facing away from the touchscreen.

In one embodiment, the step of forming the ultrasonic transducer array on the haptic feedback surface further includes: after forming the second electrode layer, forming a vibration matching layer on a surface of the second electrode layer facing away from the touchscreen.

In one embodiment, the method for preparing the display apparatus includes: forming the touchscreen; forming the ultrasonic transducer array; and after forming the touchscreen and the ultrasonic transducer array, adhering the ultrasonic transducer array to the haptic feedback surface.

### BRIEF DESCRIPTION OF THE DRAWINGS

To provide a clearer illustration of the technical solutions in the specific embodiments of the present disclosure or in the prior art, the accompanying drawings required for describing the specific embodiments or the prior art will be briefly introduced below. It is apparent that the drawings in the following description are only some embodiments of the present disclosure. For a person skilled in the art, further drawings can also be obtained based on these drawings without creative effort.

FIG. 1 is a schematic structural diagram of a display apparatus according to an embodiment of the present disclosure;

FIG. 2 is a schematic structural diagram of the display apparatus shown in FIG. 1;

FIG. 3 is a top view of the substrate in FIG. 2;

FIG. 4 is another schematic structural diagram of the display apparatus shown in FIG. 1;

FIG. 5 is yet another schematic structural diagram of the display apparatus shown in FIG. 1;

FIG. 6 to FIG. 11 are schematic structural diagrams showing the preparing process of the display apparatus shown in FIG. 2;

FIG. 12 is a schematic structural diagram of the ultrasonic transducer array in FIG. 5; and

FIG. 13 is a schematic structural diagram of the ultrasonic transducer array in FIG. 4.

### DESCRIPTION OF REFERENCE NUMERALS

1—Touchscreen; 2—Ultrasonic transducer array; 21—Substrate; 211—Through-hole; 22—Structural layer; 23—First electrode layer; 24—Piezoelectric layer; 25—Second electrode layer; 26—Vibration matching layer; 3—Adhesive layer.

### DETAILED DESCRIPTION OF EMBODIMENTS

Embodiments of the present disclosure are described in detail below. Examples of the embodiments are shown in the accompanying drawings, in which the same or similar reference numerals denote the same or similar elements or elements with the same or similar functions throughout. The embodiments described below with reference to the accompanying drawings are exemplary and are intended to explain the present disclosure, and should not be construed as limiting the present disclosure.

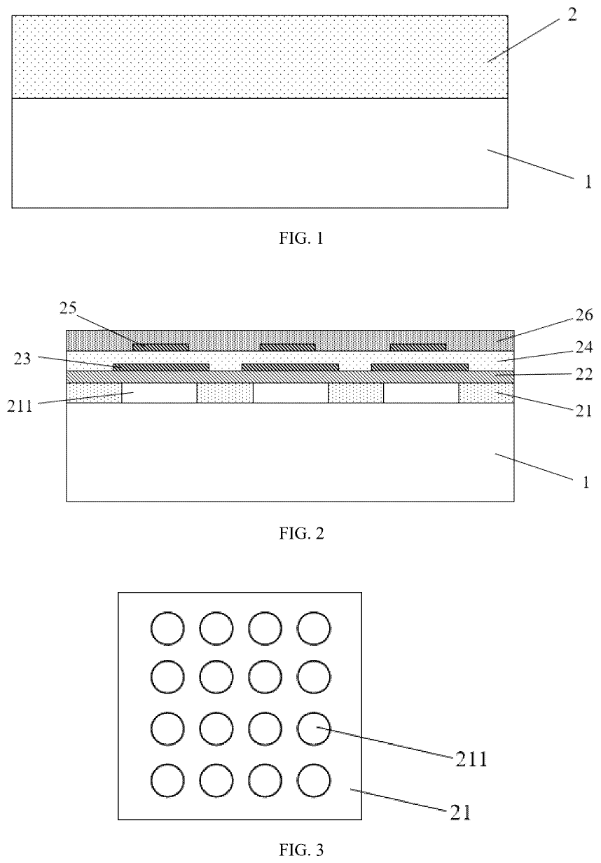

In a first aspect, referring to FIG. 1, the present disclosure provides a display apparatus, including:
a touchscreen 1, which is provided with a touch-control display surface and a haptic feedback surface that are arranged opposite to each other, the touchscreen being configured to obtain a touch position;
an ultrasonic transducer array 2, which is located on the haptic feedback surface and includes a plurality of ultrasonic transducers arranged in an array, where each of the ultrasonic transducers is configured to operate independently; and
a control module provided with an input terminal and an output terminal, where the input terminal is electrically attached to the touchscreen 1, the output terminal is electrically attached to the ultrasonic transducers, and the control module is configured to control the ultrasonic transducer located at the touch position to perform a vibration feedback.

In the aforementioned display apparatus, each ultrasonic transducer in the ultrasonic transducer array 2 is capable of operating independently, thereby enabling the display apparatus to produce haptic feedback at a touch position individually and to simultaneously provide haptic feedbacks for multiple positions, which not only improves the flexibility of the haptic feedback but also helps to reduce power consumption. Secondly, the ultrasonic transducer array 2 is located on the side of the touchscreen 1 facing away from the touch-control display surface. Therefore, it does not affect the images displayed on the touchscreen 1, nor does it occupy the space of the display region of the touchscreen 1, which is advantageous for increasing the resolution of the touchscreen 1. Furthermore, the ultrasonic transducers in the ultrasonic transducer array 2 have a high arrangement density, which is beneficial for enhancing the effect of the haptic feedback provided by the ultrasonic transducers. In addition, the ultrasonic transducer array 2 is relatively light and thin, which helps to reduce the overall size of the display apparatus.

Specifically, the steps for the display apparatus to realize haptic feedback are as follows: when a user touches the touch-control display surface of the display apparatus, the touchscreen obtains the touch position and transmits the touch position information to the control module; after the control module receives the touch position information, it sends a vibration feedback signal to several ultrasonic transducers located at the touch position; after receiving the vibration feedback signal, the several ultrasonic transducers at the touch position perform vibration feedback.

It is to be noted that the display region of the touchscreen 1 has a plurality of light-emitting elements, and the light-emitting elements emit light to display an image. If the ultrasonic transducers were to be disposed between adjacent light-emitting elements, the ultrasonic transducers would inevitably occupy the space of the display region, thereby affecting the resolution of the touchscreen 1 and reducing its display effect. At the same time, the arrangement would lower the arrangement density of the ultrasonic transducers, thus affecting the haptic feedback effect provided by them. If the ultrasonic transducer array 2 were to be disposed on the touch-control display surface, it would obstruct the image display of the touchscreen 1 and affect its display effect.

According to the embodiments of the present disclosure, the ultrasonic transducer array 2 is a piezoelectric micromachined ultrasonic transducer array or a capacitive micromachined ultrasonic transducer array.

Preferably, the ultrasonic transducer array 2 is a piezoelectric micromachined ultrasonic transducer array. When a user touches the touch-control display surface of the display apparatus, the user can experience a relatively realistic physical haptic sensation. Specifically, the steps for the aforementioned display apparatus to realize haptic feedback are as follows: when a user touches the touch-control display surface of the display apparatus, the piezoelectric layer 24 in the ultrasonic transducer array 2 undergoes deformation, thereby generating an electrical signal, and the ultrasonic transducer array 2 transmits the electrical signal to the control module; the control module calculates the touch pressure applied by the user during the touch operation based on the magnitude of the aforementioned electrical signal. Concurrently, when the user touches the touch-control display surface of the display apparatus, the touchscreen 1 obtains the touch position and transmits the touch position information to the control module. After the control module receives the touch position information, it sends a vibration feedback signal to several ultrasonic transducers located at the touch position, where the vibration feedback signal carries the touch pressure information. After receiving the vibration feedback signal, the several ultrasonic transducers at the touch position perform vibration feedback, where the vibration intensity at the touch position approximates the touch pressure of the user's touch operation, thereby allowing the user to experience a relatively realistic physical haptic sensation.

In a first embodiment, referring to FIG. 2, the piezoelectric micromachined ultrasonic transducer array includes a substrate 21, a structural layer 22, a first electrode layer 23, a piezoelectric layer 24, and a second electrode layer 25, which are sequentially stacked. Referring to FIG. 3, the substrate 21 has a plurality of through-holes 211 arranged in an array, and the surface of the structural layer 22 is exposed partially through the through-holes 211. The first electrode layer 23 and/or the second electrode layer 25 is a patterned electrode layer, where the patterned electrode layer includes a plurality of sub-electrode blocks arranged in an array, the sub-electrode blocks being each disposed opposite to one of the through-holes 211. A surface of the substrate 21 facing away from the structural layer 22 faces toward the haptic feedback surface, and the through-holes 211, the structural layer 22, and the haptic feedback surface form sealed cavities. The number of ultrasonic transducers in the ultrasonic transducer array 2 is the same as the number of the through-holes 211, and the position of each ultrasonic transducer corresponds to the position of a respective through-hole 211. Both the first electrode layer 23 and the second electrode layer 25 are electrically attached to the control module, enabling each ultrasonic transducer to be individually driven by the control module.

Specifically, the material of the substrate 21 can be single-crystal silicon or photoresist, or other materials. The structural layer 22 can be a thin metal film or a thin organic film. The piezoelectric layer 24 can be an inorganic piezoelectric thin film such as lead zirconate titanate piezoelectric ceramics (PZT) , AlN, or ZnO, or an organic piezoelectric film layer such as polyvinylidene difluoride (PVDF), polyvinylidene difluoride-trifluoroethylene copolymer (PVDF-TrFE), or polydimethylsiloxane (PDMS); the material of the first electrode layer 23 and the second electrode layer 25 can be a metal material such as Mo, Ti, or Pt, or a transparent conductive material such as Indium Tin Oxide (ITO).

Further, the thickness of the substrate 21 can be from 10 μm to 50 μm, such as 10 μm, 15 μm, 20 μm, 25 μm, 30 μm, 35 μm, 40 μm, 45 μm, or 50 μm. Referring to FIG. 3, the shape of the orthographic projection of a through-hole 211 on the structural layer 22 can be a circle, a rectangle, a hexagon, an octagon, or the like. The shapes and sizes of the through-holes 211 in the ultrasonic transducer array 2 can be the same or different. The arrangement of the sub-electrode blocks corresponds to the arrangement and shapes of the through-holes 211. When the shape of the orthographic projection of the through-hole 211 on the structural layer 22 is a circle, the inner diameter of the through-hole 211 can be from 50 μm to 500 μm, such as 50 μm, 100 μm, 150 μm, 200 μm, 250 μm, 300 μm, 350 μm, 400 μm, 450 μm, or 500 μm.

In the first embodiment, referring further to FIG. 2, the piezoelectric micromachined ultrasonic transducer further includes a vibration matching layer 26, where the vibration matching layer 26 is located on a surface of the second electrode layer 25 facing away from the piezoelectric layer 24. The vibration matching layer 26 has a low acoustic impedance and enables a high acoustic velocity, which can effectively reduce the reflection and loss of ultrasonic waves generated by the ultrasonic transducer, thereby improving the transmission efficiency of the ultrasonic waves and increasing the vibration intensity, which is beneficial for improving the haptic feedback effect. The vibration matching layer 26 can be a thin organic film such as polyurethane or polyethylene, or other materials.

In the first embodiment, preferably, both the first electrode layer 23 and the second electrode layer 25 are a patterned electrode layer. This structure can avoid interference between different ultrasonic transducers and is beneficial for accurately realizing haptic feedback. Specifically, the first electrode layer 23 includes a plurality of first sub-electrode blocks arranged in an array, and the second electrode layer 25 includes a plurality of second sub-electrode blocks arranged in an array, where the first sub-electrode blocks and the second sub-electrode blocks are each disposed opposite to one of the through-holes 211. Preferably, the second sub-electrode block is smaller in area than the first sub-electrode block. This arrangement is advantageous for achieving an improved vibration effect, thereby contributing to a better haptic feedback effect. Exemplarily, the area ratio of the second sub-electrode block to the first sub-electrode block is in a range from 0.5 to 0.8, such as 0.5, 0.55, 0.6, 0.65, 0.7, 0.75, or 0.8.

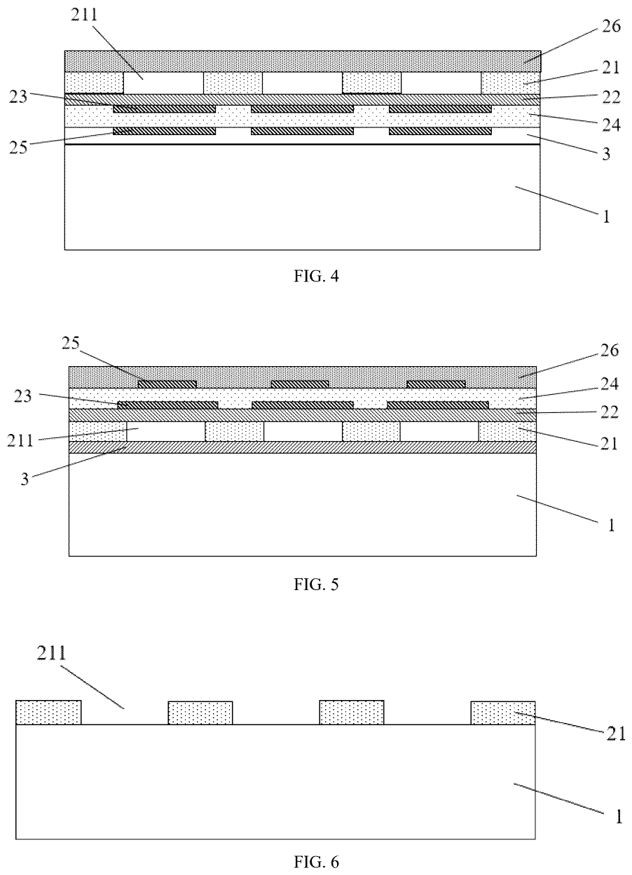

In a second embodiment, referring to FIG. 4, the piezoelectric micromachined ultrasonic transducer array includes a sealing layer, a substrate 21, a structural layer 22, a first electrode layer 23, a piezoelectric layer 24, and a second electrode layer 25, which are stacked in sequence. The substrate 21 has a plurality of through-holes 211 arranged in an array, and the through-holes 211, the structural layer 22, and the sealing layer form sealed cavities. The first electrode layer 23 and/or the second electrode layer 25 is a patterned electrode layer including a plurality of sub-electrode blocks arranged in an array, the sub-electrode blocks being each disposed opposite to one of the through-holes 211. A surface of the second electrode layer 25 facing away from the piezoelectric layer 24 faces toward the haptic feedback surface. The number of ultrasonic transducers in the ultrasonic transducer array 2 is the same as the number of the through-holes 211, and the position of each ultrasonic transducer corresponds to the position of a respective through-hole 211. Both the first electrode layer 23 and the second electrode layer 25 are electrically attached to the control module, enabling each ultrasonic transducer to be individually driven by the control module. It is to be understood that the materials and structures of the various functional layers in the piezoelectric micromachined ultrasonic transducer array of the second embodiment can be the same as those in the piezoelectric micromachined ultrasonic transducer array of the first embodiment, and thus will not be repeatedly described herein.

Preferably, the sealing layer is the vibration matching layer 26. The vibration matching layer 26 has a low acoustic impedance and enables a high acoustic velocity, which can effectively reduce the reflection and loss of ultrasonic waves generated by the ultrasonic transducer, thereby improving the transmission efficiency of the ultrasonic waves and increasing the vibration intensity, which is beneficial for improving the haptic feedback effect. The vibration matching layer 26 can be a thin organic film such as polyurethane or polyethylene, or other materials.

According to an embodiment of the present disclosure, the display apparatus can further include an adhesive layer located between the touchscreen 1 and the ultrasonic transducer array 2, to fix the ultrasonic transducer array 2 on one side surface of the touchscreen 1. FIG. 4 shows that an adhesive layer 3 is used to fix the second electrode layer 25 of the piezoelectric micromachined ultrasonic transducer array and the touchscreen 1 together. FIG. 5 shows that an adhesive layer 3 is used to fix the substrate 21 of the piezoelectric micromachined ultrasonic transducer array and the touchscreen 1 together.

According to an embodiment of the present disclosure, the touchscreen 1 includes a substrate, which is a flexible substrate. In this case, the touchscreen 1 is a flexible touchscreen, which is advantageous for improving the vibration transmission effect, and thereby contributes to an enhanced haptic feedback effect. Further, when the ultrasonic transducer array 2 is a piezoelectric micromachined ultrasonic transducer array, the flexible substrate can also better transmit the touch pressure to the piezoelectric layer 24, thereby improving the accuracy of the touch pressure calculated by the control module, which in turn allows the user to experience a more realistic physical haptic sensation.

In a second aspect, the present disclosure provides a method for preparing a display apparatus, including:
forming a touchscreen 1, which is provided with a touch-control display surface and a haptic feedback surface that are arranged opposite to each other, the touchscreen being configured to obtain a touch position;
forming an ultrasonic transducer array 2, which is located on the haptic feedback surface and includes a plurality of ultrasonic transducers arranged in an array, where each of the ultrasonic transducers is configured to operate independently; and
providing a control module provided with an input terminal and an output terminal, electrically attaching the input terminal to the touchscreen 1, electrically attaching the output terminal to the ultrasonic transducers, where the control module is configured to control the ultrasonic transducer located at the touch position to perform a vibration feedback.

In a first embodiment, the method for preparing the display apparatus includes the following steps: forming the touchscreen 1, and after forming the touchscreen 1, forming the ultrasonic transducer array 2 on the haptic feedback surface of the touchscreen 1.

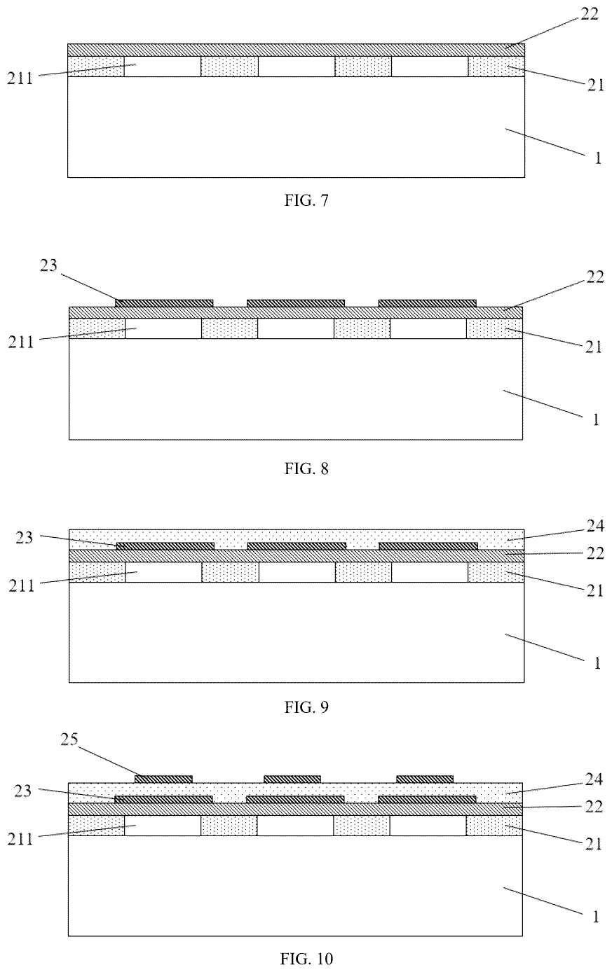

As a specific example of the first embodiment, the step of forming an ultrasonic transducer array 2 on the haptic feedback surface includes:
referring to FIG. 6, forming a substrate 21 on the haptic feedback surface, where the substrate 21 has a plurality of through-holes 211 arranged in an array; specifically, the substrate 21 can be obtained by forming a photoresist layer on the haptic feedback surface and then etching the photoresist layer; the substrate 21 can also be fabricated using other preparation methods;
referring to FIG. 7, forming a structural layer 22 on a surface of the substrate 21 facing away from the touchscreen 1, such that the through-holes 211 form sealed cavities; specifically, the structural layer 22 can be pre-fabricated and then adhered to the surface of the substrate 21 on the side facing away from the touchscreen 1; alternatively, the structural layer 22 can be formed on the surface of the substrate 21 facing away from the touchscreen 1 using other methods;
referring to FIG. 8, forming a first electrode layer 23 on a surface of the structural layer 22 facing away from the touchscreen 1;
referring to FIG. 9, forming a piezoelectric layer 24 on a surface of the first electrode layer 23 facing away from the touchscreen 1 that fully covers the surface; specifically, the piezoelectric layer 24 is formed using a process such as spin coating or magnetron sputtering;
referring to FIG. 10, forming a second electrode layer 25 on a surface of the piezoelectric layer 24 facing away from the touchscreen 1.

It is to be noted that the first electrode layer 23 and/or the second electrode layer 25 is a patterned electrode layer including sub-electrode blocks that are arranged in an array and spaced apart from each other, where the sub-electrode blocks are disposed opposite to the through-holes 211. The first electrode layer 23 in FIG. 6 and the second electrode layer 25 in FIG. 8 are each a patterned electrode layer. The method for preparing the patterned electrode layer includes the following steps: forming an electrode layer covering the full surface, where the process for forming the electrode layer covering the full surface includes, but is not limited to, vacuum evaporation or magnetron sputtering; and etching the electrode layer to obtain the patterned electrode layer.

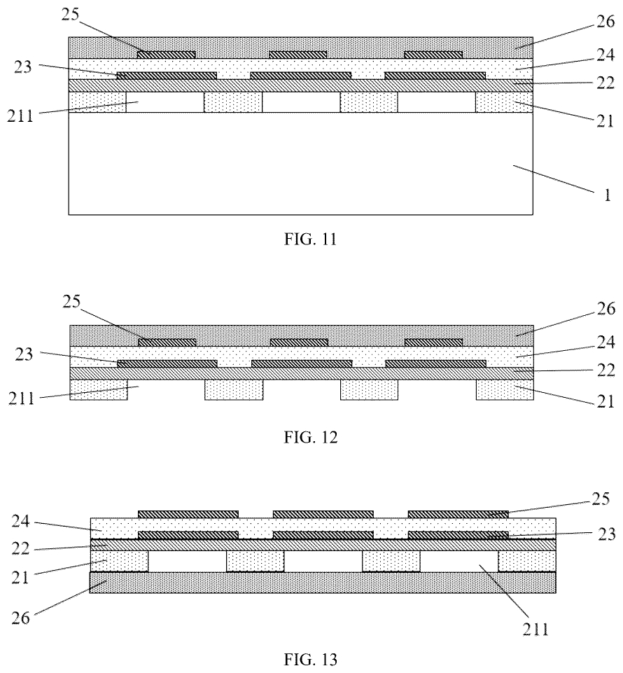

Preferably, referring to FIG. 11, the step of forming an ultrasonic transducer array 2 on the haptic feedback surface further includes: after forming the second electrode layer 25, forming a vibration matching layer 26 on a surface of the second electrode layer 25 facing away from the touchscreen 1. Specifically, the vibration matching layer 26 can be formed by methods such as slurry coating.

In a second embodiment, the method for preparing the display apparatus includes the following steps: forming the touchscreen 1; forming the ultrasonic transducer array 2; and after forming the touchscreen 1 and the ultrasonic transducer array 2, adhering the ultrasonic transducer array 2 to the haptic feedback surface. Both the touchscreen 1 and the ultrasonic transducer array 2 can be pre-fabricated in advance, which is advantageous for shortening the time required to prepare the display apparatus, thereby improving production efficiency.

As a specific example of the second embodiment, a method for preparing the ultrasonic transducer array 2 shown in FIG. 12 includes the following steps:
Step S1a: provide an initial substrate, which is used to form the substrate 21 in FIG. 12; specifically, the material of the initial substrate includes, but is not limited to, a single-crystal silicon wafer;
Step S2a: form a structural layer 22 on a surface of the initial substrate;
Step S3a: form a first electrode layer 23 on a surface of the structural layer 22 facing away from the initial substrate;
Step S4a: form a piezoelectric layer 24 on a surface of the first electrode layer 23 facing away from the initial substrate;
Step S5a: form a second electrode layer 25 on a surface of the piezoelectric layer 24 facing away from the initial substrate;
Step S6a: etch the initial substrate to obtain the substrate 21 with a plurality of through-holes 211; when the material of the initial substrate is single-crystal silicon, the method for etching the initial substrate includes, but is not limited to, deep reactive ion etching.

After the ultrasonic transducer array 2 shown in FIG. 12 is prepared, the surface of the substrate 21 facing away from the structural layer 22 is adhered to the haptic feedback surface to obtain the display apparatus shown in FIG. 5.

It is to be noted that the first electrode layer 23 and/or the second electrode layer 25 is a patterned electrode layer. The piezoelectric layer 24 and the patterned electrode layer can both be formed according to the method provided in the first embodiment, and thus will not be repeatedly described herein. The structural layer 22 can be formed using a process such as spin coating, adhering, or sputtering.

Preferably, continuing with FIG. 12, the method for preparing the ultrasonic transducer array 2 further includes: after forming the second electrode layer 25 and before etching the initial substrate, forming a vibration matching layer 26 on a surface of the second electrode layer 25 facing away from the initial substrate. The vibration matching layer 26 can be formed according to the method provided in the first embodiment, and thus will not be repeatedly described herein.

As another specific example of the second embodiment, a method for preparing the ultrasonic transducer array 2 shown in FIG. 13 includes the following steps:
Step S1b: provide an initial substrate, which is used to form the substrate 21 in FIG. 13; specifically, the material of the initial substrate includes, but is not limited to, a single-crystal silicon wafer;
Step S2b: form a structural layer 22 on a surface of the initial substrate;
Step S3b: form a first electrode layer 23 on a surface of the structural layer 22 facing away from the initial substrate;
Step S4b: form a piezoelectric layer 24 on a surface of the first electrode layer 23 facing away from the initial substrate;
Step S5b: form a second electrode layer 25 on a surface of the piezoelectric layer 24 facing away from the initial substrate;
Step S6b: etch the initial substrate to obtain the substrate 21 with a plurality of through-holes 211; when the material of the initial substrate is single-crystal silicon, the method for etching the initial substrate includes, but is not limited to, deep reactive ion etching;
Step S7b: adhere a sealing layer to a surface of the substrate 21 facing away from the structural layer 22, where the through-holes 211, the structural layer 22, and the sealing layer form sealed cavities; preferably, the sealing layer is the vibration matching layer 26.

After the ultrasonic transducer array 2 is prepared, the surface of the second electrode layer 25 facing away from the piezoelectric layer 24 is adhered to the haptic feedback surface to obtain the display apparatus shown in FIG. 4.

It is to be noted that the first electrode layer 23 and/or the second electrode layer 25 is a patterned electrode layer. The piezoelectric layer 24 and the patterned electrode layer can both be formed according to the method provided in the first embodiment, and thus will not be repeatedly described herein. The structural layer 22 can be formed using a process such as spin coating, adhering, or sputtering.

The terms “first” and “second” in the text are used for descriptive purposes only and should not be construed as indicating or implying relative importance or implicitly indicating the number of technical features indicated. Thus, a feature defined as “first” or “second” may explicitly or implicitly include one or more such features. In the description of the present application, the meaning of “a plurality of” is two or more, unless otherwise specifically and explicitly defined.

In the description of this specification, the description with reference to terms such as “an embodiment,” “an example,” “a specific example,” or “some examples” means that a particular feature, structure, material, or characteristic described in connection with the embodiment or example is included in at least one embodiment or example of the present disclosure. In this specification, the schematic representations of the above terms do not necessarily refer to the same embodiment or example. Furthermore, the particular features, structures, materials, or characteristics described may be combined in any suitable manner in any one or more embodiments or examples. In addition, without mutual contradiction, a person skilled in the art can combine and group the different embodiments or examples described in this specification and the features of different embodiments or examples.

Although the embodiments of the present disclosure have been shown and described above, it can be understood that the above-mentioned embodiments are exemplary and should not be construed as limiting the present disclosure. A person of ordinary skill in the art can make changes, modifications, substitutions, and alterations to the above-mentioned embodiments within the scope of the present disclosure.

What is claimed is:

1. A display apparatus, comprising:
a touchscreen, wherein the touchscreen is provided with a touch-control display surface and a haptic feedback surface that are arranged opposite to each other, and the touchscreen is configured to obtain a touch position;
an ultrasonic transducer array, which is located on the haptic feedback surface and comprises a plurality of ultrasonic transducers arranged in an array, wherein each of the ultrasonic transducers is configured to operate independently; and
a control module provided with an input terminal and an output terminal, wherein the input terminal is electrically attached to the touchscreen, the output terminal is electrically attached to the ultrasonic transducers, and the control module is configured to control the ultrasonic transducer located at the touch position to perform a vibration feedback.

2. The display apparatus according to claim 1, wherein the ultrasonic transducer array is a piezoelectric micromachined ultrasonic transducer array or a capacitive micromachined ultrasonic transducer array.

3. The display apparatus according to claim 2, wherein the piezoelectric micromachined ultrasonic transducer array comprises a substrate, a structural layer, a first electrode layer, a piezoelectric layer, and a second electrode layer, which are stacked in sequence;
the substrate has a plurality of through-holes arranged in an array, and the structural layer is partially exposed through the through-holes;
the first electrode layer and/or the second electrode layer is a patterned electrode layer comprising a plurality of sub-electrode blocks arranged in an array, the sub-electrode blocks being each disposed opposite to one of the through-holes;
a surface of the substrate facing away from the structural layer faces toward the haptic feedback surface; and
wherein, the piezoelectric micromachined ultrasonic transducer array further comprises a vibration matching layer located on a surface of the second electrode layer facing away from the piezoelectric layer.

4. The display apparatus according to claim 3, wherein the first electrode layer comprises a plurality of first sub-electrode blocks arranged in an array, and the second electrode layer comprises a plurality of second sub-electrode blocks arranged in an array, the first sub-electrode blocks and the second sub-electrode blocks are each disposed opposite to one of the through-holes, and the second sub-electrode block is smaller in area than the first sub-electrode block;
wherein, an area ratio of the second sub-electrode block to the first sub-electrode block is from 0.5 to 0.8.

5. The display apparatus according to claim 2, wherein the piezoelectric micromachined ultrasonic transducer array comprises a sealing layer, a substrate, a structural layer, a first electrode layer, a piezoelectric layer, and a second electrode layer, which are stacked in sequence;
the substrate has a plurality of through-holes arranged in an array, and the through-holes, the structural layer, and the sealing layer form sealed cavities;
the first electrode layer and/or the second electrode layer is a patterned electrode layer comprising a plurality of sub-electrode blocks arranged in an array, the sub-electrode blocks being each disposed opposite to one of the through-holes;
a surface of the second electrode layer facing away from the piezoelectric layer faces toward the haptic feedback surface; and
wherein, the sealing layer is a vibration matching layer.

6. The display apparatus according to claim 1, wherein the touchscreen comprises a base substrate, and the base substrate is flexible.

7. A method for preparing a display apparatus, comprising:
forming a touchscreen, wherein the touchscreen is provided with a touch-control display surface and a haptic feedback surface that are arranged opposite to each other, and the touchscreen is configured to obtain a touch position;
forming an ultrasonic transducer array, which is located on the haptic feedback surface and comprises a plurality of ultrasonic transducers arranged in an array, wherein each of the ultrasonic transducers is configured to operate independently; and
providing a control module provided with an input terminal and an output terminal, electrically attaching the input terminal to the touchscreen, and electrically attaching the output terminal to the ultrasonic transducers, wherein the control module is configured to control the ultrasonic transducer located at the touch position to perform a vibration feedback.

8. The method for preparing the display apparatus according to claim 7, comprising:
forming the touchscreen; and
after forming the touchscreen, forming the ultrasonic transducer array on the haptic feedback surface of the touchscreen.

9. The method for preparing the display apparatus according to claim 8, wherein the forming the ultrasonic transducer array on the haptic feedback surface comprises:
forming a substrate on the haptic feedback surface, wherein the substrate has a plurality of through-holes arranged in an array;
forming a structural layer on a surface of the substrate facing away from the touchscreen, wherein the through-holes form sealed cavities;
forming a first electrode layer on a surface of the structural layer facing away from the touchscreen;
forming a piezoelectric layer on a surface of the first electrode layer facing away from the touchscreen that fully covers the surface;
forming a second electrode layer on a surface of the piezoelectric layer facing away from the touchscreen;
wherein the first electrode layer and/or the second electrode layer is a patterned electrode layer comprising a plurality of sub-electrode blocks arranged in an array, the sub-electrode blocks being each disposed opposite to one of the through-holes;
wherein, the forming the substrate on the haptic feedback surface comprises: forming a photoresist layer on the haptic feedback surface, and etching the photoresist layer to obtain the substrate; and
wherein, the forming the structural layer on the surface of the substrate facing away from the touchscreen comprises: pre-fabricating the structural layer, and adhering the structural layer to the surface of the substrate facing away from the touchscreen.

10. The method for preparing the display apparatus according to claim 9, wherein the forming the ultrasonic transducer array on the haptic feedback surface further comprises:
after forming the second electrode layer, forming a vibration matching layer on a surface of the second electrode layer facing away from the touchscreen.

11. The method for preparing the display apparatus according to claim 7, comprising:
forming the touchscreen;
forming the ultrasonic transducer array; and
after forming the touchscreen and the ultrasonic transducer array, adhering the ultrasonic transducer array to the haptic feedback surface.
